(19) United States
(12) Patent Application Publication
(10) Pub. No.: US 2026/0094734 A1
(43) Pub. Date: Apr. 2, 2026

(54) RADIATION MONITORING METHOD

(71) Applicant: National Atomic Research Institute, Taoyuan (TW)

(72) Inventors: WEI-HAN CHU, Taoyuan (TW); TENG-HUNG TSOU, Taoyuan (TW); CHIEN-HAU CHU, Taoyuan (TW); I-CHUN CHO, Taoyuan (TW)

(21) Appl. No.: 18/899,045

(22) Filed: Sep. 27, 2024

(51) Int. Cl. G21F 5/06; G01T 1/167; G08B 21/12

(52) U.S. Cl. CPC G21F 5/06; G01T 1/167; G08B 21/12

(57) ABSTRACT

A radiation monitoring method is provided. The radiation monitoring method includes the following steps: installing a GPS positioning module on a radiation source body to form a mobile radiation source; transmitting a positioning information of the mobile radiation source to a controller in a monitoring center through the GPS positioning module, and accessing the positioning information through the controller; updating the positioning information to the controller in the monitoring center; performing monitoring on the radiation source body; and an instant alarm step.

### TECHNICAL FIELD

The present invention relates to a radiation monitoring method.

### BACKGROUND

Non-Destructive Testing (NDT) is a testing technology used to evaluate the properties and defects of a material, component or structure without compromising the integrity of the object, and to derive preventive or corrective measures. Although the use of NDT does not harm structures, the protection of personnel against radiation and the risks it may cause should be taken into consideration. If the loss of the radiation source occurs, it is very likely that it will cause physiological and psychological impacts on the general public, resulting in people's fear of radiation.

In the current control process, there are many units using such radiation sources and the sources are widely distributed, some of which are even remotely located, making it impossible for the management department to conduct real-time and effective monitoring of each radiation source. In addition, the existing technology mainly relies on personnel auditing, which requires huge manpower and is extremely inefficient. At the same time, due to the properties of high radiation source intensity, effective monitoring is necessary for the greater radiation damage to humans. The irregular checking may also lead to errors, and the loss or misuse of radiation sources may not be immediately detected. Therefore, solving the shortcomings or deficiencies of existing radiation monitoring methods will be one of the issues that the industry must solve.

### SUMMARY

Embodiments of the present disclosure provide a radiation monitoring method that can effectively monitor the situation of radiation sources and reduce risks that may be caused by radiation theft or loss.

One embodiment of the present disclosure provides a radiation monitoring method including the following steps: installing a GPS positioning module on a radiation source body to form a mobile radiation source; transmitting a positioning information of the mobile radiation source to a controller in a monitoring center through the GPS positioning module, and accessing the positioning information through the controller; updating the positioning information to the controller in the monitoring center; performing monitoring on the radiation source body; and an instant alarm step.

Based on the foregoing, in the radiation monitoring method of the present disclosure, automatic monitoring and real-time monitoring of NDT operational radiation source are carried out by applying a tested GPS positioning module. This monitoring process covers the radiation source storage and entry-exit management within the organization of the operator, and the tracking and positioning, and the positioning of NDT workplaces after the radiation source leaves the organization. Through the technologies such as wireless transmission, radio frequency identification (RFID), GPS regional positioning and electronic fencing, strict supervision of radiation sources in NDT operations is achieved to eliminate and prevent serious incidents such as loss of radiation sources and radiation accidents.

A detailed description is given in the following embodiments with reference to the accompanying drawings, in order to make the disclosure more comprehensible.

### BRIEF DESCRIPTION OF THE DRAWINGS

FIG. 1 is a schematic diagram of the radiation monitoring system of the present disclosure.

FIG. 2 is a schematic diagram of the GPS positioning module of the present disclosure.

FIG. 3 is a flow chart of the radiation monitoring method of the present disclosure.

### DETAILED DESCRIPTION

The following embodiments are set forth in detail with accompanying drawings, but the embodiments provided are not intended to limit the scope of the disclosure. In addition, the drawings are for illustrative purposes only and are not drawn to original size. To facilitate understanding, the same components will be identified with the same symbols in the following description.

The terms “including”, “comprising”, “having”, etc. mentioned in the disclosure are open terms, which means “including but not limited to”.

In the description of various embodiments, when describing the components in terms of “first,” “second,” “third,” “fourth,” and the like, it is used only to distinguish these components from one another, and does not limit the order or importance of these components.

In the illustrations of various embodiments, the so-called “coupling” or “connection” may refer to two or more elements being in direct physical or electrical contact with each other, or in indirect physical or electrical contact with each other, and “coupling” or “connection” may also refer to the mutual operation or action of two or more components.

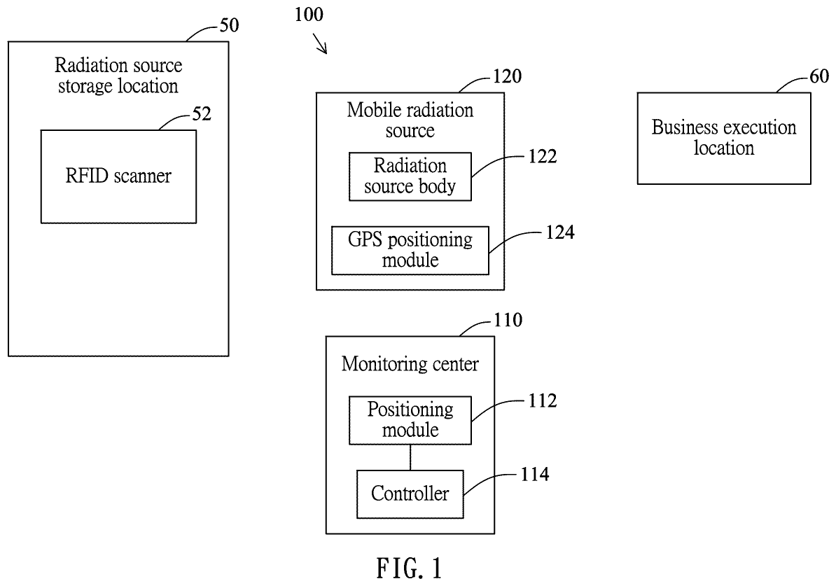

FIG. 1 is a schematic diagram of the radiation monitoring system of the present disclosure. Please refer to FIG. 1. The radiation monitoring system 100 of the present disclosure includes a monitoring center 110 and a mobile radiation source 120. The monitoring center 110 can be a physical central control room, or a cloud-based device connected to a number of hand-held electronic devices via signals, such as hand-held electronic devices of the control personnel. The monitoring center 110 includes a positioning module 112 and a controller 114. The controller 114 is connected to the positioning module 112 via signals. The positioning module 112 include, for example, positioning technologies such as GPS units for global positioning satellites and are complemented by a wireless network for connecting to a number of hand-held electronic devices via signals, such as hand-held electronic devices of the control personnel.

The mobile radiation source 120 includes a radiation source body 122 and a GPS positioning module 124. The GPS positioning module 124 is installed on the radiation source body 122. The mobile radio source 120 can be stored in a radio source storage location 50. The radio source storage location 50 can include an RFID (Radio-frequency identification) scanner 52. The mobile radiation source 120 can be moved outside the radiation source storage location 50 and into the business execution location 60. Moreover, through the GPS positioning module 124, the positioning information such as the location information, positioning time and movement status of the radiation source body 122 will be transmitted and updated to the positioning module 112 of the monitoring center 110. The positioning information of the radiation source body 122 can be stored by the controller 114 to facilitate real-time monitoring of the status of the radiation source and reduce the risk of radiation being stolen or lost.

In the present disclosure, the radiation source body 122 can be, for example, an iridium-192 (Ir-192) radiation source or a cobalt-60 (Co-60) radiation source. The iridium-192 radiation source used in non-destructive testing (NDT) operations is a Class II registered radiation source stipulated by the atomic energy commission. The cobalt-60 (Co-60) radiation source is a high dose rate radiation irradiation factory mainly used for radiation processing of items. Radiation processing technology can be used for sterilization, insect removal, material modification, etc. Its radiation source has the characteristics of high energy, strong penetrating power and high radiation source activity. However, the type of the radiation source body 122 is not limited by the present disclosure.

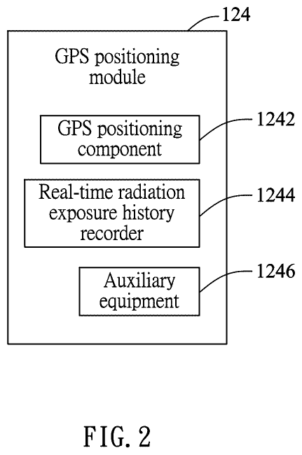

FIG. 2 is a schematic diagram of the GPS positioning module of the present disclosure. Please refer to FIG. 2. The GPS positioning module 124 at least includes a GPS positioning component 1242, a real-time radiation exposure history recorder 1244, and related auxiliary equipment 1246 to modularize them. The auxiliary equipment 1246 can include a RFID antenna, a power supply equipment, etc. Accordingly, through the GPS positioning module 124, the mobile radiation source 120 of the present disclosure can be positioned and tracked, and can be used in association with related auxiliary equipment 1246 to enhance the diversity of related control operations.

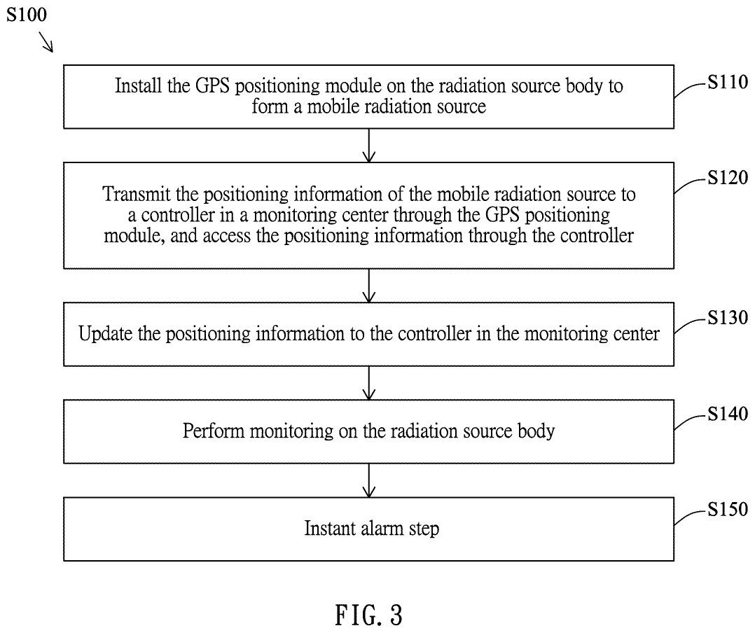

FIG. 3 is a flow chart of the radiation monitoring method of the present disclosure. Please refer to FIGS. 1 to 3. The radiation monitoring method S100 of the present disclosure includes the following steps S110 to S150. First, step S110 is performed to install the GPS positioning module 124 on the radiation source body 122 to form a mobile radiation source 120. As shown in FIG. 2, the GPS positioning module 124, the GPS positioning component 1242, the real-time radiation exposure history recorder 1244, and related auxiliary equipment 1246 are modularized into a box of a certain volume, and are installed on the surface of the radiation source body 122.

Most commercial GPS modules have not passed the anti-ionizing radiation test. Even if there are a few space-standard GPS modules that have passed the anti-radiation test, they are expensive and not easy to obtain. These products are mostly used in the satellite and aerospace industries, and do not meet the needs of the broader technological enforcement of radiation source control. Therefore, the step S110 of the radiation monitoring method S100 of the present disclosure includes the following steps. The GPS positioning module 124 of the disclosure performs the anti-ionizing radiation test step for the radiation source, so that before applying the GPS positioning module 124 of the present disclosure in the areas with high ionizing radiation intensity, by performing the radiation source anti-ionizing radiation test step, the applicability of the GPS positioning module 124 in areas with high ionizing radiation intensity is evaluated to avoid the occurrence of Single Event Effect (SEE) effect and Total Radiation Dose (Total Ionizing Dose (TID) effect, which further cause the possibility of failure of the GPS positioning module 124. In addition, the radiation source anti-ionizing radiation test step can also obtain the tolerance data of the GPS positioning module 124, in order to evaluate the service life, update the equipment in advance, and achieve the purpose of real-time monitoring.

For example, the cobalt-60 (Co-60) radiation source can be used as the radiation source body 122. By cooperating with the GPS positioning module 124, the dose rate of the cobalt-60 (Co-60) radiation source is approximately 10 rad-Si/sec (10 rads of silicon dose per second). The radiation tolerance of the GPS positioning module 124 is tested at a high dose rate, and the GPS test reliability analysis result is obtained. It can be thus determined that the cobalt-60 (Co-60) radiation source can be used and applied for the GPS positioning module 124 in high-intensity radiation exposing areas.

In one embodiment, the thickness of the radiation shielding used for high dose rate radiation exposure is more than 1.5 meters of concrete wall, and the design of the entrance maze is provided to shield the radiation to protect the surrounding people and the environment. Due to the excessive shielding thickness, the GPS satellite signals and 4G communication base station signals required for testing the GPS positioning module 124 cannot be directly transmitted to the test site. Therefore, the steps for the GPS positioning module 124 to perform the radiation source anti-ionizing radiation test include the following steps: adopting the method of zero-baseline configuration; then, performing the radiation damage assessment by comparing the performance of the component under test with that of the testing outdoor reference component (control group).

The present disclosure uses air as the dielectric material signal line of the coaxial cable for wiring, so that the attenuation of the signal after 50 meters is reduced to about 15 decibels (dB). The signal transmission path can be divided into two paths: GPS satellite signal transmission and GSM (4G-LTE) signal transmission. GSM refers to the Global System for Mobile Communications (GSM), and 4G refers to the fourth-generation mobile communication technology (4th generation), and LTE refers to Long Term Evolution technology. However, such references are provided for illustrative purposes only and are not intended to preclude the use of wireless networks or network communication technologies using other communication standards.

GPS satellite signal transmission path configuration: The GPS satellite signal connection method adopts a zero-baseline configuration. Radiation damage assessment is performed by comparing the performance of the component under test with that of the testing outdoor reference component (control group). The zero-baseline configuration has the following advantages of controlling environmental variables, increasing repeatability, and understanding equipment errors. Controlling environmental variables means using a zero-baseline configuration to minimize environmental variables (e.g., atmospheric conditions, multipath effects, etc.) that may affect the performance of the GPS receiver, allowing the tester to focus on analyzing and comparing changes in the performance of the receiver itself as a result of radiation exposure. Increasing repeatability means that the reproducibility of the results is increased because all tests are performed in the same location. This means that experiments can be repeated at different points in time or under different conditions to produce more robust results. Understanding equipment error means that systematic or random errors within the equipment can be identified by comparing the measurement results of multiple receivers in the same location.

All receivers were tested using the same external GPS antenna signal during the test. The external GPS antenna is an active antenna with a built-in linear amplifier. The antenna receives the outdoor GPS satellite signals and amplifies them by 30 dB by its built-in low-noise linear amplifier. The GPS satellite signals are then distributed to both the component under test and the testing outdoor reference component (control group) through the signal distribution regulator (splitter). The GPS satellite signal transmission uses physical connections to ensure that the strength and quality of the satellite signals received by the component under test and the reference component are consistent. Therefore, LMR-400 coaxial cable is used by the present disclosure to transmit the GPS signal. LMR-400 is a high-frequency coaxial cable which uses PE foam as the dielectric material. The foam thickness is about 5 mm to effectively increase the wire diameter of the coaxial cable and reduce signal loss during signal transmission. It can also achieve light weight and expand the application range of cables. The LMR-400 can transmit GPS signals of 1500 MHz up to 50 meters away with only about <10dB signal loss. Even at the situation of 1000 MHZ, the signal attenuation of the LMR-400 is only >20dB. Therefore, LMR-400 is more suitable for high-frequency signal transmission such as GPS than the coaxial cables of other standards. This configuration can effectively amplify and transmit GPS satellite signals to the component under test and the reference component, while eliminating the effects of systematic errors and variations in geographical location or environmental conditions at the same time.

GSM (4G-LTE) signal transmission path configuration: Since the GPS positioning module 124 of the test sample needs to transmit positioning information back to the network server through the 4G-LTE module, in order to perform real-time tracking of the position of the GPS positioning module 124. Considering that the 4G-LTE signal only needs to provide feedback text information and does not require high bandwidth, the difference in 4G-LTE signal strength between the component under test and the reference component has little impact on the integrity of the feedback message. In order to simplify the complexity of wiring, the present disclosure selects to use radio waves to transmit 4G-LTE signals. Regarding outdoors, a directional antenna is used with an RF relay (Repeater) to perform two-way signal broadcast with the base station of the 4G-LTE system supplier, to enhance the signal strength of the receiving base station. An RF relay (Repeater) is a signal enhancer used to compensate and improve signal attenuation caused by transmission in cables or other transmission media. The signal from the base station of the 4G-LTE system supplier is transmitted to the Repeater through the wire for signal amplification. Afterwards, the amplified signal is transmitted to the laboratory field through the planar directional antenna, so that both the component under test and the reference component in the field can use their own GSM (4G-LTE) antennas to send back positioning information.

After performing step S110, step S120 is then performed to transmit the positioning information of the mobile radiation source 120 to a controller 114 in a monitoring center 110 through the GPS positioning module 124, and access the positioning information through the controller 114. The positioning information of the mobile radiation source 120 includes the positioning information such as the location information of the radiation source body 122, positioning time, and movement status, which will be transmitted and updated to the positioning module 112 of the monitoring center 110 and stored as the positioning information of the radiation source body 122 by the controller 114. In one embodiment, the present disclosure can be further stored in the controller 114 in the monitoring center 110 through internet-of-things technologies such as 4G-LTE or NB-IOT (Narrowband Internet of Things).

After step S120, step S130 is performed to update the positioning information of the GPS positioning module 124 to the controller 114 in the monitoring center 110. Through the entering and exiting the inventory of the radiation source body 122, the process of moving the radiation source body 122, and the positioning information of the radiation source body 122 in the business execution location 60, the GPS positioning component 1242 as shown in FIG. 2 regularly transmits feedbacks such as the positioning information of current position and positioning time of the radiation source body 122 shown in FIG. 1 to the controller 114 for achieving the purpose of real-time tracking of the radiation source body 122.

After step S130, step S140 is performed to execute the step of monitoring the radiation source body 122. When the GPS positioning module 124 monitors the radiation source body 122 during moving, signal interruptions or large positional errors may occur due to spatial shielding. Further through the electronic fence as RFID signal conversion, the radio source in the shielding can still have signal, so as to achieve the purpose of effective tracking of the radiation source.

In one embodiment, the step of monitoring the radiation source body 122 includes the following steps. The controller 114 in the monitoring center 110 obtains the current longitude and latitude coordinate values of the corresponding GPS positioning component 1242 based on the positioning information of the GPS positioning module 124. Afterwards, based on the current longitude and latitude coordinate values of the GPS positioning component 1242, the controller 114 in the monitoring center 110 determines whether an error occurs in the position of the radiation source body 122. For example, the positioning information such as current location of the radiation source body 122, its trajectory, and its movement speed, are determined on the electronic map. When the values of the received positioning information exceeds a reasonable range (such as the positional error is too large), it is further necessary to request the source management personnel to assist in confirming the status of the radiation source body 122 for real-time monitoring and processing.

In one embodiment, the step of monitoring the radiation source body 122 includes the following steps. The GPS positioning module 124 enters the electronic fence mode, so that although the radiation source body y 122 is blocked by the spatial shielding causing signal interruption, the electronic fence mode still allows the radiation source body 122 to generate a signal. Specifically, the last positioning position of the GPS positioning component 1242 in the GPS positioning module 124 is used as the center of the circle to plan an electronic fence with a specific range width. In addition, through the wireless communication network of the mobile operator (such as GSM network, LTE network), a combination of base station data is used to provide location information for the GPS positioning component 1242.

In one embodiment, the step of monitoring the radiation source body 122 includes the following steps. The auxiliary equipment 1246 in the GPS positioning module 124, such as an RFID antenna, is used to assist in converting the RFID signal. Accordingly, the radiation source body 122 can still generate a signal to assist in positioning the location of the radiation source body 122 and effectively achieve the purpose of tracking the radiation source body 122.

In one embodiment, the step of monitoring the radiation source body 122 includes the following steps. The real-time radiation exposure history recorder 1244 in the GPS positioning module 124 is used to detect the radiation exposure history of the GPS positioning component 1242 and record the cumulative exposure dose instantly.

After the above step S140, step S150 is performed, which is an immediate alarm step. If it is determined that the change in the location information of the radiation source body 122 exceeds the permitted range, the controller 114 of the monitoring center 110 automatically generates an abnormality alarm and uses the text message system to notify the source management personnel to assist in reporting and confirming the status of the radiation source body 122 and the positioning device, and to send staff to audit if necessary.

The following examples illustrate three control scenarios that can be applied to the radiation monitoring method S100 of the present disclosure and the radiation monitoring system 100 of the present disclosure.

Please refer to FIGS. 1 and 2. Embodiment 1: Control of entering and exiting the inventory for the radiation source body 122. An RFID scanner 52 is installed at the entrance of the radiation source storage location 50 planned by the NDT operator. When the radiation source body 122 enters the radiation source storage location 50, the RFID scanner 52 will receive the RFID barcode in the GPS positioning component 1242, feedback a radiation source entrance message through technologies such as 4G-LTE or NB-IOT to the controller 114 of the monitoring center 110, and turn off the power supply equipment of the auxiliary equipment 1246 at the same time to turn off the GPS positioning component 1242 for extending service life of the GPS positioning component 1242. When the operator takes out the radiation source body 122, the radiation source number will also be identified through RFID to activate the power of the GPS positioning component 1242 at the same time. Meanwhile, after the radiation source body 122 has been taken out and has not returned to the radiation source storage location 50 within 24 hours, the GPS positioning component 1242 will also issue a warning message to the controller 114 of the monitoring center 110. The monitoring center 110 will use the text message system to notify the source management personnel of the operator to request assistance in confirming the status of the radiation source.

Please refer to FIGS. 1 and 2. Embodiment 2: Movement control of the mobile radiation source 120. When the mobile radiation source 120 is carried from the radiation source storage location 50, the radiation source number will be identified by RFID technology, and the power supply device of the auxiliary equipment 1246 will be activated simultaneously to turn on the GPS positioning component 1242 for continuous position monitoring. The GPS positioning component 1242 will regularly report its current location and last positioning time. The controller 114 of the monitoring center 110 can obtain the current longitude and latitude coordinate values of the GPS positioning component 1242 based on the received signal, and determine information such as current location of the radiation source and its trajectory and movement speed on the electronic map. When the received value exceeds a reasonable range, the monitoring center 110 can use the text message system to notify the source management personnel of the operator and request assistance in confirming the status of the mobile radiation source 120. If a radiation source is lost, the above information can be used for quickly positioning the radiation source location.

Please refer to FIGS. 1 and 2. Embodiment 3: The mobile radiation source 120 is controlled indoors at the business execution location 60. When the GPS positioning component 1242 enters the business execution location 60 and cannot successfully obtain the GPS positioning signal, the GPS positioning component 1242 automatically enters the electronic fence mode and uses the positioning location finally positioned by the GPS positioning component 1242 as the center of the circle to plan an electronic fence with a specific range width, to use a combination of base station data to provide location information through the radio communication network (such as GSM network, LTE network) of the mobile operator. The electronic fence system uses the distance positioning of the 4G-LTE module and the base station. The positioning error of GPS is 10 meters, while the error of base station positioning is larger. The positioning error in urban areas is about 50 meters, and the error in suburban areas is greater than 50 meters. Nevertheless, the advantage of using base station positioning is that it can overcome the limitations of GPS signal penetration.

Please refer to FIGS. 1 and 2. Embodiment 4: Real-time recording of the radiation exposure process of the GPS positioning module 124 used for monitoring the mobile radiation source 120. By utilizing the real-time radiation exposure history recorder 1244 in the GPS positioning module 124, the radiation exposure history of the GPS positioning component 1242 is detected and the cumulative exposure dose is recorded instantly. The real-time radiation exposure history recorder 1244 can be a Geiger-Müller counter, a semiconductor dosimeter or a thermoluminescent dosimeter, etc., so as to continuously detect the radiation exposure history of the GPS positioning component 1242 and record the cumulative exposure dose instantly. The GPS positioning component 1242 can be replaced in advance before the failure dose is reached to reduce the loss and theft of radiation source and tracking control problems due to failure of the GPS positioning component 1242.

Based on the foregoing, in the radiation monitoring method of the present disclosure, automatic monitoring and real-time monitoring of NDT operational radiation source are carried out by applying a tested GPS positioning module. This monitoring process covers the radiation source storage and entry-exit management within the organization of the operator, and the tracking and positioning, and the positioning of NDT workplaces after the radiation source leaves the organization. Through the technologies such as wireless transmission, radio frequency identification (RFID), GPS regional positioning and electronic fencing, strict supervision of radiation sources in NDT operations is achieved to eliminate and prevent serious incidents such as loss of radiation sources and radiation accidents.

Although the disclosure has been disclosed in the form of embodiments, it is not intended to limit the present disclosure. Anyone with general knowledge in the field of technology may make some changes and modifications without departing from the spirit and scope of the present disclosure, and therefore the scope of protection of the disclosure shall be subject to the scope of the patent application attached hereto.

What is claimed is:

1. A radiation monitoring method, comprising the following steps:
installing a GPS positioning module on a radiation source body to form a mobile radiation source;
transmitting a positioning information of the mobile radiation source to a controller in a monitoring center through the GPS positioning module, and accessing the positioning information through the controller;
updating the positioning information to the controller in the monitoring center;
performing monitoring on the radiation source body; and
an instant alarm step.

2. The radiation monitoring method according to claim 1, wherein the step of installing the GPS positioning module on the radiation source body comprises the following step:
installing a GPS positioning component, a real-time radiation exposure history recorder and an auxiliary equipment on a surface of the radiation source body.

3. The radiation monitoring method according to claim 1, wherein the step of installing the GPS positioning module on the radiation source body comprises the following step:
performing a radiation source anti-ionizing radiation test step on the GPS positioning module.

4. The radiation monitoring method according to claim 3, wherein the step of performing the radiation source anti-ionizing radiation test step on the GPS positioning module comprises the following step:
adopting a zero-baseline configuration; and
comparing a component under test and a testing outdoor reference component to perform a radiation damage assessment.

5. The radiation monitoring method according to claim 4, wherein the step of adopting the zero-baseline configuration comprises the following step:
using a high-frequency coaxial cable of dielectric material for wiring.

6. The radiation monitoring method according to claim 1, wherein the step of performing monitoring on the radiation source body comprises the following step:
obtaining a coordinate value corresponding to a GPS positioning component in the GPS positioning module based on the positioning information of the GPS positioning module by the controller in the monitoring center; and
determining whether there is an error in a location of the radiation source body based on the coordinate value of the GPS positioning component by the controller in the monitoring center.

7. The radiation monitoring method according to claim 1, wherein the step of performing monitoring on the radiation source body comprises the following step:
the GPS positioning module entering an electronic fence mode.

8. The radiation monitoring method according to claim 1, wherein the step of performing monitoring on the radiation source body comprises the following step:
using an RFID antenna in the GPS positioning module to assist in positioning a location of the radiation source body.

9. The radiation monitoring method according to claim 1, wherein the step of performing monitoring on the radiation source body comprises the following step:
detecting a radiation exposure history of the GPS positioning component in the GPS positioning module and instantly recording a cumulative exposure dose through a real-time radiation exposure history recorder in the GPS positioning module.
